(19) United States
(12) Patent Application Publication
(10) Pub. No.: US 2010/0142357 A1
(43) Pub. Date: Jun. 10, 2010

(54) OBJECTIVE LENS SYSTEM AND OPTICAL PICKUP DEVICE

(75) Inventors: Michihiro YAMAGATA, Osaka (JP); Fumitomo YAMASAKI, Nara (JP); Yoshiaki KOMMA, Osaka (JP); Katsuhiko HAYASHI, Nara (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/603,695

(22) Filed: Oct. 22, 2009

Related U.S. Application Data
(60) Provisional application No. 61/107,766, filed on Oct. 23, 2008.

(30) Foreign Application Priority Data
Oct. 21, 2009 (JP) 2009-242616

(51) Int. Cl. G11B 7/135

(52) U.S. Cl. 369/112.23; G9B/7.112

(57) ABSTRACT

Provided are an optical pickup device which is compatible with a plurality of disc standards, and can stably monitor the outputs from light sources, and an objective lens system used in the optical pickup device. An optical pickup device 50 includes a light source 1 emitting light of a first wavelength of a red band and light of a second wavelength of an infrared band; a light source 10 emitting light of a blue-violet band for BD 10; a collimating lens 4; mirrors 5, 7 each transmitting a portion of a light beam outputted from the collimating lens 4 while folding an optical path of the other portion of the light beam; objective lenses 6, 8 each converging the light beam folded by the mirrors 5, 7 on a recording layer of an optical disc; and a light-receiving element 15 detecting an intensity of the light beam transmitted through the mirrors 5, 7. The collimating lens 4 adjusts the parallelisms of the lights emitted from the light sources 1, 10, and outputs the light of the first wavelength as a converging light beam, and the light of the second wavelength as a diverging light beam.

### BACKGROUND OF THE INVENTION

1. Field of the Invention

The present invention relates to an objective lens system for performing at least one of recording, reproduction, and erasing of information on an optical storage medium, and an optical pickup device using the objective lens system.

2. Description of the Background Art

Optical discs have been widely used as media for recording a large amount of information. A compact disc (CD) was widespread first. Thereafter, improvement of recording density was achieved to store more information in a single information storage medium, and consequently, a digital versatile disc (DVD) was developed. Recently, a Blu-ray disc (registered trademark, BD) capable of recording information with higher density have been put to practical use.

In order to realize a high-density optical disc, it is necessary to reduce the size of pits for recording. Therefore, with the improvement of recording density, the numerical aperture of an objective lens used in an optical pickup device has been increased, and the wavelength of laser light has been shortened. Further, an optical disc is provided with a protection layer formed of a light-permeable resin, in order to protect an information recording layer. The thickness of this protection layer varies depending on the standards of optical discs.

A device for recording/reproducing information on/from an optical disc is desired to be compatible with a plurality of standards. Since a technique to achieve CD/DVD compatibility has already been practically used, a configuration in which an optical system for BD only is combined with a CD/DVD compatible optical system is adopted to ensure, with relative ease, compatibility among the standards of these three discs. One of the prior art documents relating to the present invention is International Publication WO 2007/069612.

### SUMMARY OF THE INVENTION

In the case of configuring a thin optical pickup device to be used in a notebook PC or the like, sharing a part of an optical path among lights of different wavelengths is advantageous for size reduction. To be specific, lights emitted from light sources corresponding to BD, DVD, and CD, respectively, are synthesized by using a prism or the like, and the synthesized light beam is converted to a substantially parallel light beam by using a single collimating lens. Thereafter, the optical path is wavelength-selectively folded by using a mirror for DVD/CD or a mirror for BD to guide the light beam to an objective lens corresponding to each of the standards.

For example, when performing DVD recording/reproduction, the emitted light for DVD is transmitted through the collimating lens, and the optical path of the light is folded by an upward reflection mirror to be guided to an objective lens. At this time, a part of the light beam is transmitted through the upward reflection mirror, and enters a light-receiving element (front light monitor) that is provided behind the upward reflection mirror. The light intensity monitored by the light-receiving element is used to control the output from the light source.

Assuming that the optical path for BD is overlapped with the optical path for DVD/CD, the above-described upward reflection mirror is desired to have a plate shape so that no aberration occurs on the transmitting optical path for BD. However, since such a plate-shaped mirror has a thickness, the incident light beam is not only simply transmitted through the plate-shaped mirror, but a portion of the incident light beam is reflected by an inner surface of the plate-shaped mirror and then outputted from the plate-shaped mirror. In this case, the light beam reflected by the inner surface of the plate-shaped mirror interfaces with the transmitted light beam, which causes a problem that the output from the monitor light-receiving element becomes unstable.

Further, there is a case where lights of different wavelengths are simultaneously emitted from the respective light sources, for the purpose of determining the type of an optical disc when the optical disc is loaded in an optical disc recording/reproducing device. However, in the configuration where a part of the optical path is shared as described above, the lights of the different wavelengths, which have been simultaneously emitted, are synthesized to enter the monitor light-receiving element, leading to false detection of light intensity.

Therefore, the present invention is made to solve the above-described problems and has for its object to provide an optical pickup device which is compatible with a plurality of disc standards, and is capable of stably monitoring outputs from light sources, and an objective lens system to be used in the optical pickup device.

An optical pickup device according to the present invention performs, using light of a first wavelength, at least one of reading, writing, and erasing of information on a first optical recording medium having, on a recording layer, a protection layer of a first thickness, and performs, using light of a second wavelength that is longer than the first wavelength, at least one of reading, writing, and erasing of information on a second optical recording medium having, on a recording layer, a protection layer of a second thickness that is larger than the first thickness. The optical pickup device includes a light source that emits the light of the first wavelength and the light of the second wavelength; a parallelism adjusting element that adjusts parallelisms of the lights emitted from the light source, and outputs the light of the first wavelength as a converging light beam, and the light of the second wavelength as a diverging light beam; a mirror provided on an optical path of the light beam outputted from the parallelism adjusting element, the mirror transmitting a portion of the incident light beam, while folding the optical path of the other portion of the incident light beam; an objective lens system that converges the light beam folded by the mirror to form a beam spot on the recording layer of the first or second optical recording medium; and a light-receiving element that detects an intensity of the light beam transmitted through the mirror.

An objective lens system according to the present invention is used in an optical pickup device that performs, using light of a first wavelength, at least one of reading, writing, and erasing of information on a first optical recording medium having, on a recording layer, a protection layer of a first thickness, and performs, using light of a second wavelength that is longer than the first wavelength, at least one of reading, writing, and erasing of information on a second optical recording medium having, on a recording layer, a protection layer of a second thickness that is larger than the first thickness. The objective lens system is configured such that a spherical aberration that occurs when a converging light beam of the first wavelength enters the objective lens system is smaller than a spherical aberration that occurs when a parallel light beam of the first wavelength enters the objective lens system, and a spherical aberration that occurs when a diverging light beam of the second wavelength enters the objective lens system is smaller than a spherical aberration that occurs when a parallel light beam of the second wavelength enters the objective lens system.

According to the present invention, in the case where an optical pickup device having a mirror for folding a light beam to be guided to an objective lens is configured, the light beam to be guided to the mirror can be converted to non-parallel light. Thereby, interference fringes caused by reflection inside the mirror can be controlled, and thus monitoring of the optical output intensity based on the light transmitted through the mirror can be performed stably.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of an optical pickup device according to an embodiment of the present invention;

FIG. 2A is a diagram showing an optical path of an objective lens (when a DVD is used) according to the embodiment of the present invention;

FIG. 2B is a diagram showing an optical path of the objective lens (when a CD is used) according to the embodiment of the present invention; and

FIG. 3 is a diagram in which phase differences (values obtained from a phase function) given by a diffraction surface of an objective lens according to Numerical Example 1 are plotted.

### DESCRIPTION OF THE PREFERRED EMBODIMENTS

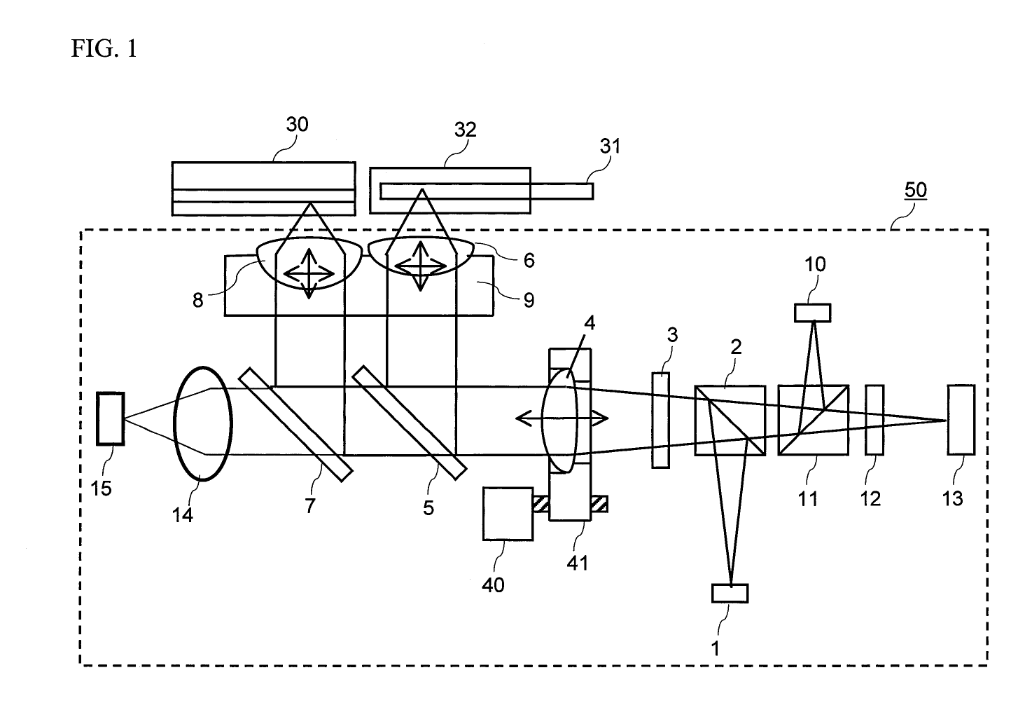

FIG. 1 is a diagram showing a schematic configuration of an optical pickup device according to an embodiment of the present invention.

The optical pickup device 50 according to this embodiment is compatible with three optical discs, i.e., a BD 30, a DVD 31, and a CD 32, and is configured by using an objective lens 8 for BD and an objective lens 6 for DVD/CD. More specifically, the optical pickup device 50 includes: a light source 1 that emits light of a first wavelength (red light for DVD), and light of a second wavelength longer than the first wavelength (infrared light for CD); a light source 10 which emits light of a third wavelength shorter than the first wavelength (blue-violet light for BD); beam splitters 2 and 11; a ¼ wave plate 3; a collimating lens 4; plate-shaped mirrors 5 and 7 each having wavelength selectivity; an objective lens 6 for DVD/CD; an objective lens 9 for BD; an actuator 9 that drives the objective lenses 6 and 9 in a direction parallel to the optical disc surface and in a direction perpendicular to the optical disc surface; a converging lens 14; and a light-receiving element 15 for monitoring the output intensity, which is capable of detecting the lights of the first to third wavelengths.

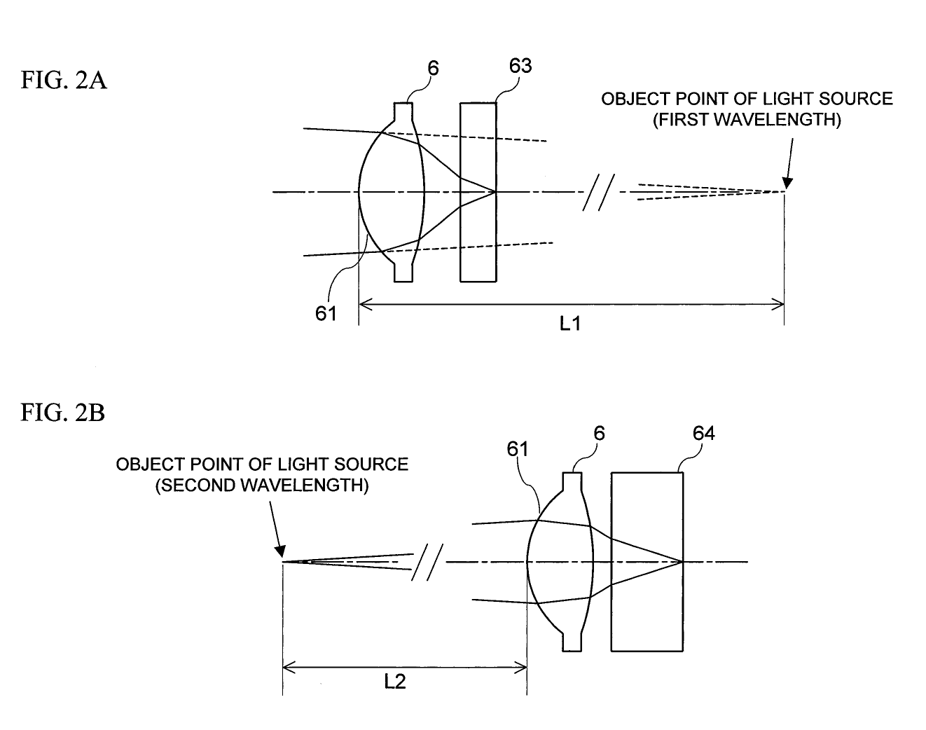

FIGS. 2A and 2B are diagrams each showing an optical path of the objective lens according to the embodiment of the present invention. More specifically, FIG. 2A shows the optical path during recording/reproduction of information on/from the DVD, and FIG. 2B shows the optical path during recording/reproduction of information on/from the CD.

The objective lens 6 according to the present embodiment is designed so that, when the light of the first wavelength (red band) for DVD is used, a spherical aberration that occurs when a converging light beam enters an incident surface 61 is smaller than a spherical aberration that occurs when a parallel light beam of the same wavelength enters the incident surface 61. At the same time, the objective lens 6 is designed so that, when the light of the second wavelength (infrared band) for CD is used, a spherical aberration that occurs when a diverging light beam enters the incident surface 61 is smaller than a spherical aberration that occurs when a parallel light beam of the same wavelength enters the incident surface 61.

Further, the optical pickup device and the objective lens system according to the present embodiment satisfy the following conditions.

L1+L2≦0 (1)

L1/L2≦−1 (2)

wherein,

L1 is an object point distance from the incident surface of the objective lens system to an object point of the light source of the first wavelength, and

L2 is an object point distance from the incident surface of the objective lens system to an object point of the light source of the second wavelength.

Note that the object point distance is positive when the object point is positioned on the light source side with respect to the incident surface 61 of the objective lens 6, and is negative when the object point is positioned on the optical disc side.

The thickness of a protection layer 64 provided on a recording layer of the CD is larger than the thickness of a protection layer 63 provided on a recording layer of the DVD. When the light of the first wavelength for DVD is used, the objective lens 6 forms a beam spot at a position where the light beam has transmitted through the protection layer 63. When the light of the second wavelength for CD is used, the objective lens 6 forms a beam spot at a position where the light beam has transmitted through the protection layer 64. At this time, an aberration occurs due to the protection layers 63 and 64. Therefore, when the objective lens is designed, the thicknesses of the protection layers are considered so as to favorably correct the spherical aberration that occurs when the light beam is converged. As described above, the objective lens 6 according to the present embodiment is designed so that an aberration is favorably corrected when a nonparallel light beam enters. Accordingly, the thickness of the protection layer, which minimizes a third-order spherical aberration on the recording layer when a parallel light beam of the red band wavelength for DVD enters the objective lens 6, deviates from 0.6 mm that is defined in the DVD standards.

Turning to FIG. 1, when performing recording, or reproduction, or erasing of information on the BD 30, the light of the third wavelength (blue-violet band) is emitted from the light source 10. The emitted linearly-polarized light is reflected by the beam splitter 11, and converted to circularly-polarized light by the ¼ wave plate 3. The circularly-polarized light enters the collimating lens 4.

The collimating lens 4 is fixed to a collimating lens holder 41, and is movable in the optical axis direction by a stepping motor 40. When the thickness of the protection layer provided on the information recording layer of the optical disc is different from the prescribed thickness, the collimating lens 4 is shifted toward a direction parallel to the light axis, thereby to change the parallelism of the incident light beams to the objective lenses 6 and 8. A spherical aberration is generated in the objective lens 8, whereby the spherical aberration that occurs due to a difference in thickness between the light-transmitting layers can be corrected. Further, examples of media of the BD 30 include a medium having only a single recording layer, and a medium having a plurality of recording layers laminated via an intermediate layer. When the BD 30 has a plurality of recording layers, the collimating lens 4 is shifted in a direction perpendicular to the optical axis, thereby to adjust the focusing position in accordance with each recording layer, and correct a spherical aberration in the beam spot.

The light beam outputted from the collimating lens 4 is transmitted through the mirror 5 having wavelength selectivity, reflected by the mirror 7, and converged on the information recording layer of the BD 30 by the objective lens 8. The light beam reflected by the information recording layer is again transmitted through the objective lens 8, reflected by the reflection mirror 7, and transmitted through the collimating lens 4. The light beam transmitted through the collimating lens 4 is converted, by the ¼ wave plate, to linearly-polarized light that is different from the linearly-polarized light in the path from the light source to the disc. The linearly-polarized light is transmitted through the beam splitters 2 and 11, and converged on a photodetector 13 by a detection lens 12. The photodetector 13 performs photoelectric conversion on the incident light to generate a signal output.

Next, when performing recording, reproduction, or erasing of information on the DVD 31, light of the first wavelength (red band) is emitted from the light source 1 comprising a dual-wavelength semiconductor laser element or the like. The emitted linearly-polarized light is reflected by the beam splitter 11, and converted to circularly polarized light by the ¼ wave plate 3. The circularly polarized light enters the collimating lens 4. When the light of the first wavelength is used, the collimating lens 4 is shifted by the stepping motor 40 in a direction away from the light source 1 relative to the position where it collimates the incident light, and thereby a light beam that is slightly converged as compared with the parallel light beam is outputted from the collimating lens 4. The slightly-converged light beam outputted from the collimating lens 4 is reflected by the mirror 5 having wavelength selectivity, and converged on the information recording layer of the DVD 31 by the objective lens 6. The objective lens 6 according to the present embodiment is designed so that a spherical aberration that occurs when a converged light beam of the first wavelength (red band) enters the objective lens 6 is smaller than a spherical aberration that occurs when a parallel light beam of the same wavelength enters the objective lens 6.

The light beam reflected by the information recording layer is again transmitted through the objective lens 6, reflected by the reflection mirror 5, and transmitted through the collimating lens 4. The light beam transmitted through the collimating lens 4 is converted, by the ¼ wave plate, to linearly polarized light that is different from the linearly polarized light in the path from the light source to the disc. Then, the linearly polarized light is transmitted through the beam splitters 2 and 11, and converged on the photodetector 13 by the detection lens 12. The photodetector 13 performs photoelectric conversion on the incident light to generate a signal output.

Next, when performing recording, reproduction, or erasing of information on the CD 32, light of the second wavelength (infrared band) is emitted from the light source 1. The emitted linearly-polarized light is reflected by the beam splitter 11, and converted to circularly polarized light by the ¼ wave plate 3. The circularly polarized light enters the collimating lens 4. When the light of the second wavelength is used, the collimating lens 4 is shifted by the stepping motor 40 in a direction approaching the light source 1 relative to the position where it collimates the incident light, and thereby a light beam that is slightly diverged as compared with the parallel light beam is outputted from the collimating lens 4. The slightly-diverged light beam outputted from the collimating lens 4 is reflected by the mirror 5 having wavelength selectivity, and converged on the information recording layer of the CD 32 by the objective lens 6. The objective lens 6 according to the present embodiment is designed so that a spherical aberration that occurs when a diverged light beam of the second wavelength (infrared band) enters the objective lens 6 is smaller than a spherical aberration that occurs when a parallel light beam of the same wavelength enters the objective lens 6.

The light beam reflected by the information recording layer is again transmitted through the objective lens 6, reflected by the reflection mirror 5, and transmitted through the collimating lens 4. The light beam transmitted through the collimating lens 4 is converted, by the ¼ wave plate, to linearly polarized light that is different from the linearly polarized light in the path from the light source to the disc. Then, the linearly polarized light is transmitted through the beam splitters 2 and 11, and converged on the photodetector 13 by the detection lens 12. The photodetector 13 performs photoelectric conversion on the incident light to generate a signal output.

Although the light beams emitted from the light sources 1 and 10 are reflected by the mirror 5 or 7 so as to be used for recording, reproduction, or erasing of information on/from the optical disc, portions of the light beams are transmitted through the mirrors 5 and 7, and converged, by the converging lens 14, on the light-receiving element 15 for monitoring the output intensity. The light-receiving element 15 performs photoelectric conversion on the incident light beams, and a control circuit (not shown) generates signal outputs for adjusting the light intensities of the light sources 1 and 10.

In the optical pickup device having the above-described optical configuration, it is possible to, when the lights of the first and second wavelengths are used, adjust the position of the collimating lens 4 in the direction along the optical axis so that a parallel light beam is outputted from the collimating lens 4. In this case, however, the light beam that has been multiply-reflected inside the plate-shaped mirrors 5 and 7 interferes with the light beam that has been transmitted without being multiply-reflected, resulting in interference fringes on the light-receiving surface of the light-receiving element 15. The interference fringes cause unstable monitor output, which makes it very difficult to control the light intensities of the light sources 1 and 10.

In the optical pickup device 50 according to the present embodiment, the position of the collimating lens 4 in the optical axis direction is adjusted, and thereby a diverging light beam is outputted from the collimating lens 4 when the light of the first wavelength for CD is used, while a converging light beam is outputted from the collimating lens 4 when the light of the second wavelength for DVD is used. Further, when the light of the third wavelength for BD is used, the collimating lens 4 is shifted in the optical axis direction, and thereby the parallelism of the light beam is adjusted according to the depth of the recording layer or the thickness of the protection layer. In this manner, by adjusting the parallelisms of the light beams incident on the mirrors 5 and 7, it is possible to change the difference in optical path between the light beam that is multiply-reflected and then enters the light-receiving element 15 and the light beam that enters the light-receiving element 15 without being multiply reflected. Thereby, the interference fringes can be made sufficiently fine with respect to the size of the light-receiving surface of the light-receiving element 15. As a result, the outputs of the light sources can be stably controlled.

Furthermore, in the optical pickup device 50 according to the present embodiment, the collimating lens 4 converts the light of the first wavelength and the light of the second wavelength, which are emitted from the light source 1, to a converging light beam and a diverging light beam, respectively. Therefore, the parallelism of the light beam outputted from the collimating lens 4 varies among the first to third wavelengths. Accordingly, even when lights of different wavelengths are simultaneously emitted for the purpose of determining the type of an optical disc when it is loaded, the positions where the lights of the respective wavelengths are converged on the light-receiving surface of the light-receiving element 15 can be shifted by varying, for each wavelength, the incident angles of the light beams from the collimating lens 4 to the mirror 5. Accordingly, even when the plurality of light sources simultaneously emit lights as described above, the light intensities of the light sources can be appropriately determined and controlled for each wavelength.

In the present embodiment, the optical pickup device 50 having the objective lens 6 for DVD/CD and the objective lens 8 for BD has been described. However, the present invention is also applicable to an optical pickup device having only a DVD/CD compatible objective lens, an optical pickup device having only a BD/DVD compatible objective lens, and an optical pickup device having only a BD/CD compatible objective lens. Also in these cases, the same technological effect as that of the optical pickup device according to the present embodiment can be obtained by diverging or converging light of a wavelength for DVD and light of a wavelength for CD, which enter the mirror.

Further, in the present embodiment, the collimating lens 4 is used for diverging or converging the light beam that enters the mirror 5. However, the present invention is not restricted thereto. For example, a beam expander, and an aberration correcting element having, on its surface, a diffraction structure having stairs-like steps or saw-tooth steps, may be used as components of a parallelism adjusting element for adjusting the parallelism of the incident light beam to the mirror 5, and at least one of the components of the parallelism adjusting element may be shifted in the direction perpendicular to the optical axis.

Furthermore, in the present embodiment, the number of elements constituting the objective lens system, and the number of elements constituting the optical system for adjusting the parallelism of the light beam may be arbitrarily set.

### EXAMPLES

Hereinafter, specific numerical examples of the objective lens system according to the present invention will be described. In each numerical example, an aspheric configuration is represented by the following formula.

$$X = \frac{{h}^{2} / r}{1 + \sqrt{1 - ( 1 + K ) {( h / r )}^{2}}} + {\sum }_{n} {A}_{n} {h}^{n}$$

where,

X is a distance from a point on an aspheric surface, at a height h from the optical axis, to a tangential plane at a top of the aspheric surface,

h is the height from the optical axis,

R is a curvature radius at the top of the aspheric surface,

K is a conic constant, and

An is an n-th order aspheric coefficient.

Further, a diffraction surface is represented by the following formula.

$$p = M {\sum }_{n} {D}_{n} {h}^{n}$$

where,

p is a phase difference due to a diffraction surface,

h is the height from the optical axis,

Dn is an n-th order phase function coefficient, and

M is a diffraction order.

### Numerical Example 1

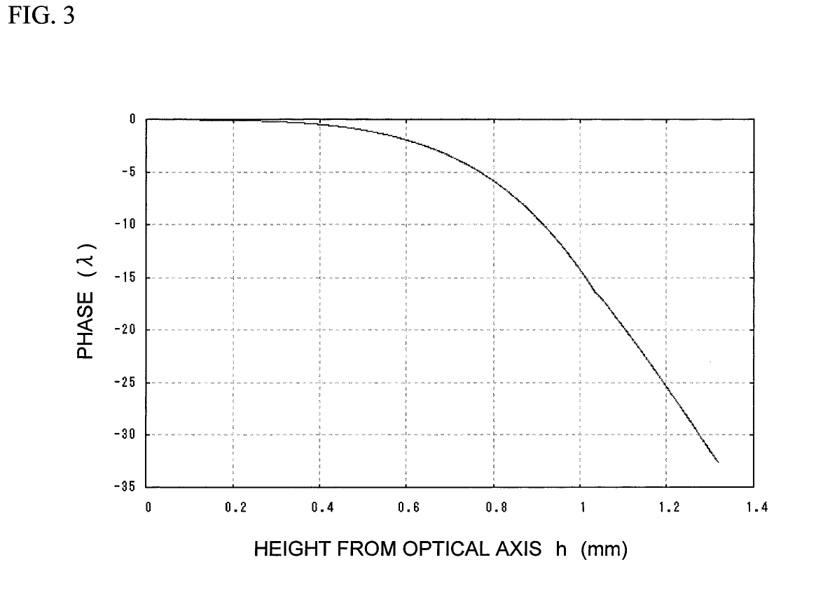

On a first surface (incident surface) of an objective lens system according to Numerical Example 1, different aspheric configurations are formed at an inner part having a height of 1.037 or below from the optical axis, and at an outer part having a height exceeding 1.037 from the optical axis. On this surface, substantially saw-tooth-shaped diffraction zones are formed in accordance with the phase function. FIG. 3 is a diagram in which phase differences (values obtained from the phase function) given by the diffraction surface of the objective lens according to Numerical Example 1 are plotted.

Table 1 shows the specification of the objective lens system according to Numerical Example 1.

TABLE 1

| | | DVD | CD |
|---|---|---|---|
| Wavelength (nm) | | 0.66 | 0.785 |
| Refractive index | Lens | 1.539481 | 1.535912 |
| | Protection layer | 1.578152 | 1.572031 |

| Object point distance (mm) | −167 | 130 |
|---|---|---|
| Protection layer thickness (mm) | 0.6 | 1.2 |
| Lens thickness (mm) | 1.1 | |
| Focal length (mm) | 1.996 | 2.008 |
| Axial wavefront aberration (mλ) | 5.1 | 4.1 |

Table 2 shows aspheric coefficients and phase function coefficients of the objective lens system according to Numerical Example 2. Note that the diffraction order is the first order.

TABLE 2

| | | | |
|---|---|---|---|
| First surface | h ≦ 1.037 | R | 1.2925658E+00 |
| | | K | −8.0674282E−01 |
| | | A4 | 2.3542039E−02 |
| | | A6 | −1.4280534E−02 |
| | | A8 | 1.5390087E−02 |
| | | A10 | −5.7171449E−03 |
| | | D2 | −5.0000000E+00 |
| | | D4 | −7.6603540E+01 |
| | | D6 | −7.9821413E+00 |
| | h > 1.037 | R | 1.2720147E+00 |
| | | K | −8.9856505E−01 |
| | | A4 | 8.2169689E−03 |
| | | A6 | −1.0070393E−03 |
| | | A8 | 1.7359988E−02 |
| | | A10 | −7.0586838E−03 |
| | | A12 | 3.0117727E−04 |
| | | D2 | −5.3994170E+00 |
| | | D4 | −1.1551266E+02 |
| | | D6 | 2.9315211E+01 |
| Second surface | | R | −4.6147921E+00 |
| | | K | −8.5822783E+01 |
| | | A4 | 2.4785002E−02 |
| | | A6 | −4.2687478E−03 |
| | | A8 | −7.0893695E−03 |
| | | A10 | 2.1850108E−03 |

### Numerical Example 2

On a first surface (incident surface) of an objective lens system according to Numerical Example 1, different aspheric configurations are formed at an inner part having a height of 1.037 or below from the optical axis, and at an outer part having a height exceeding 1.037 from the optical axis. Also on a second surface, different aspheric configurations are formed at an inner part having a height of 0.842 or below from the optical axis, and at an outer part having a height exceeding 0.842 from the optical axis.

Table 3 shows the specification of the objective lens system according to Numerical Example 2.

TABLE 3

| | | DVD | CD |
|---|---|---|---|
| Wavelength (nm) | | 0.66 | 0.785 |
| Refractive index | Lens | 1.539481 | 1.535912 |
| | Disc | 1.578152 | 1.572031 |

| | | |
|---|---|---|
| Object point distance (mm) | −167 | 130 |
| Disc thickness (mm) | 0.6 | 1.2 |

| | |
|---|---|
| Lens thickness (mm) | 1.1 |

| | | |
|---|---|---|
| Focal length (mm) | 1.996 | 2.009 |
| Axial wavefront aberration (mλ) | 3.1 | 7.3 |

Table 4 shows aspheric coefficients and phase function coefficients of the objective lens system according to Numerical Example 2. Note that the diffraction order is the first order.

TABLE 4

| | | | |
|---|---|---|---|
| First surface | h ≦ 1.037 | RD | 1.2893205E+00 |
| | | CC | −7.4439206E−01 |
| | | A4 | 2.9088486E−02 |
| | | A6 | −3.4529028E−02 |
| | | A8 | 2.1482385E−02 |
| | | A10 | −9.1395235E−04 |
| | | D2 | 8.8453567E−06 |
| | | D4 | −7.3545957E+01 |
| | | D6 | −1.1557843E+01 |
| | h > 1.037 | RD | 1.3167811E+00 |
| | | CC | −8.4904258E−01 |
| | | A4 | 2.7433963E−02 |
| | | A6 | −6.4090979E−04 |
| | | A8 | 8.9211119E−03 |
| | | A10 | −7.6333794E−03 |
| | | A12 | 1.7396638E−03 |
| | | D2 | −1.3176796E+02 |
| | | D4 | 7.3236800E+01 |
| | | D6 | −3.6621420E+01 |
| Second surface | h ≦ 0.842 | RD | −4.5647471E+00 |
| | | CC | −1.5482843E+02 |
| | | A4 | −4.0791254E−03 |
| | | A6 | −2.1001232E−02 |
| | | A8 | 7.9104615E−02 |
| | | A10 | −4.0687894E−02 |
| | h > 0.842 | RD | −6.1142905E+00 |
| | | CC | −3.4469644E+01 |
| | | A4 | 2.8614334E−02 |
| | | A6 | −1.9099591E−02 |
| | | A8 | 6.9574003E−03 |
| | | A10 | −9.5262706E−04 |

### Numerical Example 3

On a first surface (incident surface) of an objective lens system according to Numerical Example 1, different aspheric configurations are formed at an inner part having a height of 1.05 or below from the optical axis, and at an outer part having a height exceeding 1.05 from the optical axis.

Table 5 shows the specification of the objective lens system according to Numerical Example 3.

TABLE 5

| | | DVD | CD |
|---|---|---|---|
| Wavelength (nm) | | 0.66 | 0.785 |
| Refractive index | Lens | 1.539481 | 1.535912 |
| | Disc | 1.578152 | 1.572031 |

| | | |
|---|---|---|
| Optical point distance (mm) | −600 | 600 |
| Disc thickness (mm) | 0.64 | 1.12 |

| | |
|---|---|
| Lens thickness (mm) | 1.1 |

| | | |
|---|---|---|
| Focal length (mm) | 1.996 | 2.009 |
| Axial wavefront aberration (mλ) | 15.3 | 11.03 |

Table 6 shows aspheric coefficients and phase function coefficients of the objective lens system according to Numerical Example 3. Note that the diffraction order is the first order.

TABLE 6

| | | | |
|---|---|---|---|
| First Surface | h ≦ 1.05 | RD | 1.3330902E+00 |
| | | CC | 1.3839376E−01 |
| | | A4 | −8.2852145E−03 |
| | | A6 | −6.3438840E−02 |
| | | A8 | 5.9338530E−02 |
| | | A10 | −3.7475418E−02 |
| | | D2 | −5.5223173E+01 |
| | | D4 | −4.8105469E+00 |
| | | D6 | −3.4973197E+00 |
| | h > 1.05 | RD | 1.3685839E+00 |
| | | CC | −9.5396293E−01 |
| | | A0 | 1.7126986E−02 |
| | | A4 | 2.1456036E−02 |
| | | A6 | −2.0062979E−03 |
| | | A8 | 2.8336643E−02 |
| | | A10 | −1.2279667E−02 |
| | | D2 | −5.6456121E+01 |
| | | D4 | 2.1198239E+01 |
| | | D6 | −2.6171460E+01 |
| Second Surface | | RD | −4.4739330E+00 |
| | | CC | −5.0867530E+01 |
| | | A4 | 2.9142433E−02 |
| | | A6 | −5.4523037E−03 |
| | | A8 | 3.4724293E−05 |
| | | A10 | −3.7076774E−03 |
| | | A12 | 1.0122851E−03 |

### Numerical Example 4

On a first surface (incident surface) of an objective lens system according to Numerical Example 1, different aspheric configurations are formed at an inner part having a height of 1.037 or below from the optical axis, and at an outer part having a height exceeding 1.037 from the optical axis. Also on a second surface, different aspheric configurations are formed at an inner part having a height of 0.842 or below from the optical axis, and at an outer part having a height exceeding 0.842 from the optical axis.

Table 7 shows the specification of the objective lens system according to Numerical Example 4.

TABLE 7

| | | DVD | CD |
|---|---|---|---|
| Wavelength (nm) | | 0.66 | 0.785 |
| Refractive index | Lens | 1.539481 | 1.535912 |
| | Disc | 1.578152 | 1.572031 |

| | | |
|---|---|---|
| Object point distance (mm) | −167 | 130 |
| Disc thickness (mm) | 0.6 | 1.2 |

| | |
|---|---|
| Lens thickness (mm) | 1.1 |

| | | |
|---|---|---|
| Focal length (mm) | 1.996 | 2.009 |
| Axial wavefront aberration (mλ) | 5.15 | 10.45 |

Table 8 shows aspheric coefficients and phase function coefficients of the objective lens system according to Numerical Example 4. Note that the diffraction order is the first order.

TABLE 8

| | | | |
|---|---|---|---|
| First surface | h ≦ 1.037 | RD | 1.2895044E+00 |
| | | CC | −7.9257934E−01 |
| | | A4 | 2.2926765E−02 |
| | | A6 | −8.1308417E−03 |
| | | A8 | −7.5695516E−04 |
| | | A10 | 1.7834462E−03 |
| | | D2 | −2.7555250E−01 |
| | | D4 | −7.4238461E+01 |
| | | D6 | −9.0017153E+00 |
| | h > 1.05 | RD | 1.3309032E+00 |
| | | CC | −7.7592039E−01 |
| | | A0 | 1.8990241E−02 |
| | | A4 | 2.2068669E−03 |
| | | A6 | 1.2029678E−02 |
| | | A8 | −6.5282564E−03 |
| | | A10 | 2.1499031E−04 |
| | | D2 | −1.1521789E+02 |
| | | D4 | 5.8519025E+01 |
| | | D6 | −3.1684589E+01 |
| Second surface | h ≦ 0.842 | RD | −4.5527002E+00 |
| | | CC | −1.0312327E+02 |
| | | A4 | 2.3288204E−02 |
| | | A6 | −3.3360084E−02 |
| | | A8 | 2.2771940E−02 |
| | | A10 | −3.1618676E−03 |
| | h > 0.842 | RD | −4.6173878E+00 |
| | | CC | −5.6492432E+01 |
| | | A4 | 3.4365506E−02 |
| | | A6 | −1.1994566E−02 |
| | | A8 | −3.6316569E−03 |
| | | A10 | 1.4971334E−03 |

The present invention is applicable to, for example, an optical pickup device which performs at least one of recording, reproduction, and erasing of information on an optical disc.

While the invention has been described in detail, the foregoing description is in all aspects illustrative and not restrictive. It is understood that numerous other modifications and variations can be devised without departing from the scope of the invention.

1. An optical pickup device which performs, using light of a first wavelength, at least one of reading, writing, and erasing of information on a first optical recording medium having, on a recording layer, a protection layer of a first thickness, and performs, using light of a second wavelength that is longer than the first wavelength, at least one of reading, writing, and erasing of information on a second optical recording medium having, on a recording layer, a protection layer of a second thickness that is larger than the first thickness, the optical pickup device comprising:
a first light source that emits the light of the first wavelength and the light of the second wavelength;
a parallelism adjusting element that adjusts parallelisms of the lights emitted from the light source, and outputs the light of the first wavelength as a converging light beam, and the light of the second wavelength as a diverging light beam;
a first mirror provided on an optical path of the light beam outputted from the parallelism adjusting element, the first mirror folding the optical path of a portion of the incident light beam of the first or second wavelength, while transmitting the other portion of the incident light beam of the first or second wavelength;
a first objective lens system that converges the light beam folded by the first mirror to form a beam spot on the recording layer of the first or second optical recording medium; and
a light-receiving element that detects an intensity of the light beam transmitted through the first mirror.

2. The optical pickup device according to claim 1, wherein:
a spherical aberration that occurs when the converging light beam of the first wavelength enters the first objective lens system is smaller than a spherical aberration that occurs when a parallel light beam of the first wavelength enters the first objective lens system; and
a spherical aberration that occurs when the diverging light beam of the second wavelength enters the first objective lens system is smaller than a spherical aberration that occurs when a parallel light beam of the second wavelength enters the first objective lens system.

3. The optical pickup device according to claim 1, satisfying the following conditions:
L1+L2≦0 (1)
L1/L2≦−1 (2)
where,
L1 is a distance from an incident surface of the first objective lens system to an object point of the light source of the first wavelength, and
L2 is a distance from the incident surface of the first objective lens system to an object point of the light source of the second wavelength.

4. An optical pickup device according to claim 1, wherein:
a thickness of the protection layer, which minimizes a spherical aberration on a recording surface of the first optical recording medium when a parallel light beam of the first wavelength enters, is different from the first thickness that is defined in the standards of the first optical recording medium.

5. The optical pickup device according to claim 1 which further performs, using light of a third wavelength that is shorter than the first wavelength, at least one of reading, writing, and erasing of information on a third optical recording medium having, on a recording layer, a protection layer of a third thickness that is smaller than the first thickness, the optical pickup device including:
a second light source that emits the light of the third wavelength to the parallelism adjusting element;
a second mirror that is provided on the optical path of the light beam outputted from the parallelism adjusting element, the second mirror folding the optical path of a portion of the incident light beam of the third wavelength, while transmitting the other portion of the incident light beam of the third wavelength and the light beams of the first and second wavelengths;
a second objective lens system that converges the light beam folded by the second mirror to form a beam spot on the recording layer of the third optical recording medium; and
the light-receiving element further detecting an intensity of the light beam of the third wavelength which has been transmitted through the first and second mirrors.

6. An objective lens system used in an optical pickup device that performs, using light of a first wavelength, at least one of reading, writing, and erasing of information on a first optical recording medium having, on a recording layer, a protection layer of a first thickness, and performs, using light of a second wavelength that is longer than the first wavelength, at least one of reading, writing, and erasing of information on a second optical recording medium having, on a recording layer, a protection layer of a second thickness that is larger than the first thickness, wherein:
a spherical aberration that occurs when a converging light beam of the first wavelength enters the objective lens system is smaller than a spherical aberration that occurs when a parallel light beam of the first wavelength enters the objective lens system; and
a spherical aberration that occurs when a diverging light beam of the second wavelength enters the objective lens system is smaller than a spherical aberration that occurs when a parallel light beam of the second wavelength enters the objective lens system.

7. An objective lens system according to claim 6, satisfying the following conditions:
L1+L2≦0 (1)
L1/L2≦−1 (2)
where,
L1 is a distance from an incident surface of the objective lens system to an object point of the light source of the first wavelength, and
L2 is a distance from the incident surface of the objective lens system to an object point of the light source of the second wavelength.

8. An objective lens system according to claim 6, wherein:
a thickness of the protection layer, which minimizes a spherical aberration on a recording surface of the first optical recording medium when a parallel light beam of the first wavelength enters, is different from the first thickness that is defined in the standards of the first optical recording medium.
